(19) United States
(12) Patent Application Publication
(10) Pub. No.: US 2026/0153749 A1
(43) Pub. Date: Jun. 4, 2026

(54) Reversible Eyewear That Pivots At The Nose Bridge

(71) Applicant: Isaac Benjamin Maresky, TORONTO (CA)

(72) Inventor: Isaac Benjamin Maresky, TORONTO (CA)

(21) Appl. No.: 18/967,546

(22) Filed: Dec. 3, 2024

(51) Int. Cl. G02C 5/00; G02C 1/06; G02C 5/04; G02C 5/22

(52) U.S. Cl. CPC G02C 5/006; G02C 1/06; G02C 5/04; G02C 5/22

(57) ABSTRACT

Reversible eyewear equipped with a nose bridge separating two eye rim lens frames from each other and connected to each so as to enable the two eye rim lens frames to move from a 180 degrees orientation with respect to each other to an obtuse angulation with respect to each other for both of the reversible orientations as desired to that the orientation of the eye rim lens frames conforms more closely to the contour of the wearer's face around the wearer's eyes than if they remained in the 180 degrees orientation to provide improved comfort to the wearer.

### STATEMENT REGARDING PRIOR DISCLOSURES BY THE INVENTOR

Through Peeq Corp., the present inventor offered for sale over one year ago reversible eyewear that was equipped with magnets in its lens frame that were in close proximity to magnetically attractive elements in the vicinity of hinge between the lens frame and temple pieces.

### BACKGROUND OF THE INVENTION

### Field of the Invention

The invention relates to reversible eyewear worn about the head that pivots at the nose bridge and a method of reversing an orientation of the temple arms relative to the lens frame with hinge units and pivoting same at the nose bridge.

### Discussion of Related Art

U.S. Pat. No. 7,494,219 B2, which is incorporated herein by reference, provides for eyewear for redirected viewing with auxiliary lenses. It includes a soft rubber bridge on the inside edge of its visor that spreads the weight of the spectacles over the wearer's forehead, further increasing the wearer's comfort. The soft rubber bridge, in combination with the entire shape of the spectacles, positions the visor and the prisms away from the brow line of a wearer allowing for the spectacles to lay over most conventional prescription or sunglass eyewear.

U.S. Pat. No. 9,726,900 B1, which is incorporated herein by reference, discloses a magnetically locking reversible eyewear and method of reversing orientation of same. Peeq Corp. (hereinafter “Peeq”) acquired ownership of U.S. Pat. No. 9,726,900 B1. Over the years, Peeq has iterated several generations of prototypes, testing different options of technologies and materials. Peeq designed 5 different models for the very first launch batch and are available for purchase on the website peeqglasses.com.

The Peeq sunglasses have a locking mechanism that has a dual-rotating hinge that enables the horizontal reversing of the temple pieces and that allows the color of the temple pieces across the entire length to be reversible including the entire endpiece of the lens frame and the temple pieces to bend down around the wearer's ear for better fit and for preventing the Peeq sunglasses from sliding off face. That is, when one reverses the temple pieces vertically, they must be completely flat because any bend down around the ear would conversely bend up above the ear when reversed.

It would be desirable to provide for non-magnetic, reversible eyewear whose outside facing color of its temple pieces is reversible with the rotation of the temple pieces via a dual-rotating hinge and configured to provide flexibility for better fit around the ear to prevent sliding off the face. Preferably, a locking mechanism provides sufficient force to keep the dual-rotating hinge in position until it is rotated under manual force to carry out the reversibility action for the temple pieces.

Chinese utility patent no. CN204044446U discloses software myopia Sports-type glasses, which include an elastic rubber headband, a soft frame and a soft transparent silica gel eyeglass. For adapting to the shape of face of different people and improving comfort level, the soft frame has two lens hole frames and an adjustable soft rubber nose bridge for adjusting two lens hole frame distances. The two lens hole frames are coupled together by the adjustable soft rubber nose bridge.

According to U.S. Pat. No. 7,494,219 B2, a visor side panel may have a soft rubber nose bridge on the inside edge of the visor to spread the weight of the spectacles over the wearer's forehead, further increasing the wearer's comfort. The soft rubber bridge, in combination with the entire shape of the spectacles, positions the visor and the prisms away from the brow line of a wearer allowing for the spectacles to lay over most conventional prescription or sunglasses eyewear.

### BRIEF SUMMARY OF THE INVENTION

One aspect of the invention resides in reversible eyewear that has a lens frame, a pair of temple arms and a pair of hinge units. The lens frame includes two eye rim frames and nose bridge between the two eye rim frames that may pivot.

The hinge units connect the pair of temple arms to opposite ends of the lens frame, which is elongated between the opposite ends. Each hinge unit has a respective locking piece that is rotatable between two relative positions. Preferably there are no magnets.

The two eye rims each bound an associated one of two lenses and terminate into respective endpieces distal from the nose bridge. The nose bridge is preferably flexible, such as made of soft rubber, to accommodate pivoting of the two eye rims relative to the nose bridge into relative positions and retain the two eye rims in the relative positions until a manual force is exerted to reposition the two eye rims relative to the nose bridge. Alternatively, the nose bridge may have hardware that enables pivoting.

### BRIEF DESCRIPTION OF SEVERAL VIEWS OF THE DRAWING

For a better understanding of the present invention, reference is made to the following description and accompanying drawings, while the scope of the invention is set forth in the appended claims.

FIG. 1 is an isometric view of conventional eyewear with its locking units in locked positions and its temple pieces extending rearward from the lens frame in a non-reversed position in accordance with U.S. Pat. No. 9,726,900 B1.

FIG. 2 is an isometric view of conventional eyewear as in FIG. 1, but with one of its locking units rotated into an unlocked position from the locked position of FIG. 1.

FIG. 3 is an isometric view of conventional eyewear as in FIG. 2 with one of its locking pieces in the unlocked position, but with its temple piece extending out to the side horizontally after having been pivoted from its rearward orientation in FIG. 2.

FIG. 4 is an isometric view of conventional eyewear with the one of its locking pieces in a locked position after being rotated from the unlocked position of FIG. 3 and with its associated temple piece in a reversed position from that of FIG. 1 after being further pivoted from its orientation in FIG. 3.

FIG. 5 is an exploded view of the conventional eyewear of U.S. Pat. No. 9,726,900 B1.

FIG. 6 is a partially enlarged and exploded perspective view illustrating a conventional bridge device of an embodiment of foldable, compact glasses illustrated in the embodiment of FIG. 2 of U.S. Pat. No. 5,896,185.

FIG. 7 is a partially enlarged and assembled perspective view illustrating the conventional bridge device of the embodiment of the foldable compact glasses illustrated in FIG. 3 of U.S. Pat. No. 5,896,185;

FIG. 8 is a cross-sectional schematic view of the conventional bridge device of the embodiment of the foldable compact glasses in operation of FIG. 4 of U.S. Pat. No. 5,896,185;

FIG. 9 is a partially enlarged and exploded perspective view illustrating a further embodiment according to FIG. 6 of U.S. Pat. No. 5,896,185;

FIG. 10 is a partially enlarged and assembled perspective view illustrating a conventional bridge device of the further embodiment of the foldable compact glasses illustrated in FIG. 7 of U.S. Pat. No. 5,896,185;

FIG. 11 a cross-sectional schematic view of the conventional bridge device of the further embodiment of the foldable compact glasses in operation of FIG. 8 of U.S. Pat. No. 5,896,185; and

FIG. 12 is a front isometric view of reversible eyewear in accordance with a further embodiment.

FIG. 13 is a progressive top view showing the reversible eyewear of FIG. 12 moving from an undeployed orientation into either of two deployed positions and showing the wearing of the reversible eyewear onto the wearer's head accordingly that faces in either of two opposite directions.

### DETAILED DESCRIPTION OF THE INVENTION

The contents of U.S. Pat. No. 9,726,900 B1 are incorporated by reference in its entirety.

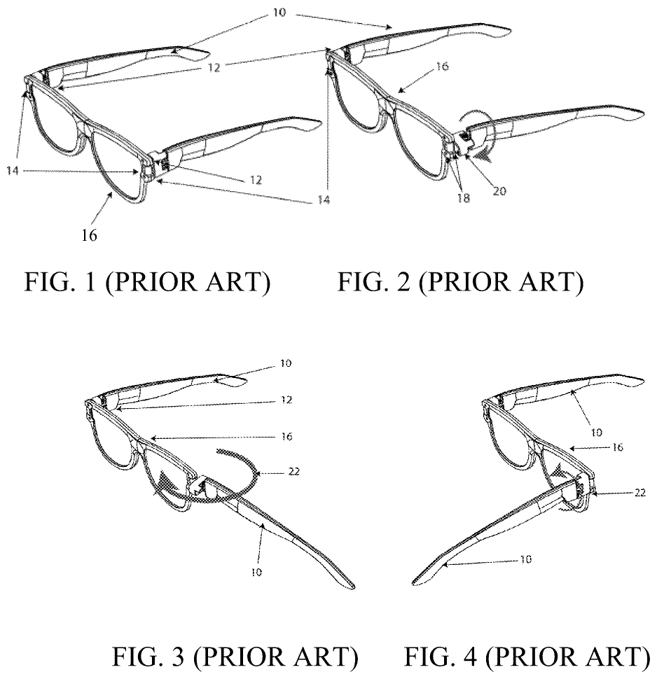

U.S. Pat. No. 9,726,900 B1 depicts and describes reversible eyewear. Turning to the drawing, FIGS. 1-4 show progressive views of conventional eyewear. The eyewear includes two temple pieces 10, two hinge units 12, two opposite ends 14 of a lens frame 16 that has a magnetically attractive element 18. Each hinge unit 12 has a rotatable locking unit 20, which likewise has a magnetically attractive element 18. The locking unit 20 of FIG. 1 may be rotated clockwise from its relative position (where the magnetic attractive elements 18 are attracted to each other in a magnetically locked position) to reach the relative position of FIG. 2 (where the magnetically attractive elements 18 are clear of each other in a magnetically unlocked position and thus cease to be in magnetic attraction with each other).

FIG. 1 shows the temple pieces 10 in their initial orientation extending rearward from the lens frame 16. In order to reverse the orientation of the temple arms relative to the lens frame, the following manual operation is performed. First, the rotatable locking piece 20 is rotated from its locked position of FIG. 1 to an unlocked position of FIG. 2. Next, the unlocked one of the temple pieces 10 is pivoted in a horizontal plane to the orientation of FIG. 3 and continued in the direction of the direction arrow until reaching the reversed position of FIG. 4 and the unlocked locking unit 20 is rotated into its locked position.

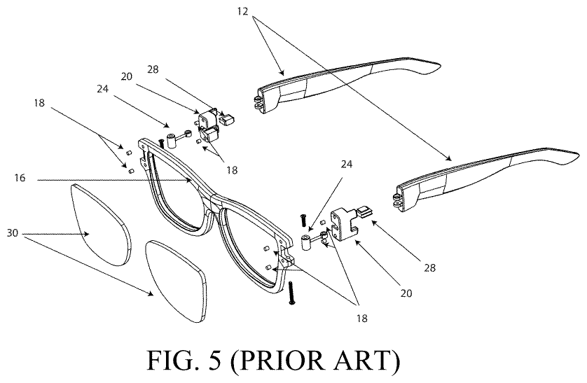

Turning to FIG. 5, U.S. Pat. No. 9,726,900 B1 employs corresponding magnets 18 In its lens frame 16 and its locking units 20 that are magnetically attractive to each other so as to provide magnetic force for retaining the locking units 20 in their locked position. The lens frame 16 is shown into which is fitted lenses 30 in a conventional manner. The temple pieces 10 connect to ends of the lens frame via hinge units. Each hinge unit includes a hinge piece 24, the locking unit 20 and a link piece 28 as well as a pair of magnets 18 that lock the hinge piece in place by coupling with a complementary pair of magnets in frame 16. The hinge piece 24 is connected to the end of the lens frame in a conventional manner with conventional fasteners and is connected to the link piece 28 such that the locking piece 20 is freely rotatable on the hinge piece 24. The link piece 28 is connected to the temple arm 10 in a conventional manner.

Peeq Corp. commercializes reversible sunglass eyewear based on U.S. Pat. No. 9,726,900 B1. The present inventor experimented with that Peeq Corp. reversible eyewear by removing its magnets from the frame and found that the temple pieces are restrained against relative movement sufficiently that they do not self-close. Instead, manual force is needed to move them between their open and closed positions.

The present inventor has found that the reversible feature functions satisfactorily even if all the magnets are removed and holes for them are filled in.

U.S. Pat. No. 5,896,185, whose contents are incorporated herein by reference, discloses a pair of foldable compact eyeglasses that includes two frames each provided with a hinge device at the outer sides thereof. Two temples respectively pivot about the hinge devices. A bridge device connects the two frames. The bridge device can be folded about the normal axes of the frames such that the glasses can be subsequently received within a rigid container after folding.

Turning to FIGS. 6-8, the bridge device 100 includes two bridge blocks 102 (only one is illustrated in FIG. 6) that are integrally formed with the frames 13 and oppositely project from the upper inner ends of the frames 13, and a link block 104. The free end of the bridge block 102 is formed with a pivotal opening 1022 parallel to the normal axes of the frames 13 and the end surface and top surface of the bridge block 102 are respectively formed with recesses 1024, 1026. The link block 104 is disposed between the bridge blocks 102 along the horizontal axis, and the opposite ends of which link block 104 are each formed with a pivotal seat 1042 for pivotally connecting the link block 104 to the free end of the bridge block 102 by means of a pin 108 passing through the pivotal opening 1022 and the pivotal seat 1042.

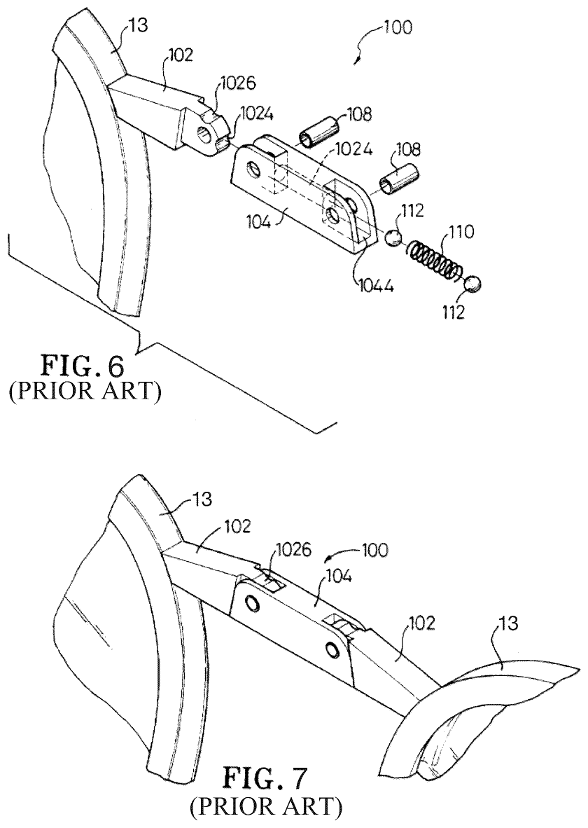

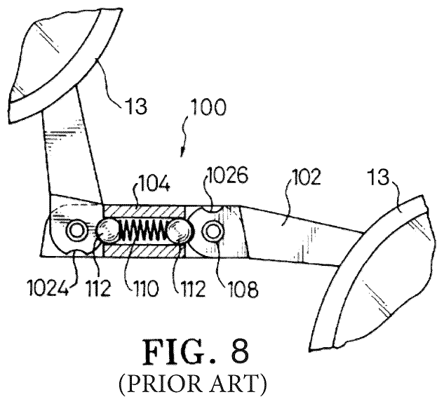

The pivotal seat 1042 can be formed with a bottom stop block 1044 for preventing the bridge device from rotating downwards. The link block 104 is formed with a horizontally though hole 1046 at the center thereof for receiving a compression spring 110 and two balls 112, wherein the balls 112 are disposed at the opposite ends of the spring 110. The length of the through hole 1046 is slightly smaller than the summation of the diameter of the balls 112 and the length of the compression spring 110 such that the ends of the balls 112 slightly protrude out of the through hole 1046 after assembly whereby the balls 112 are elastically secured within the recesses 1024, 1026 formed at the free ends of the bridge blocks 102. FIG. 7 illustrates the bridge device 100 after assembly. The cross-sectionally schematic view of FIG. 8 illustrates the inter-operation relation among components.

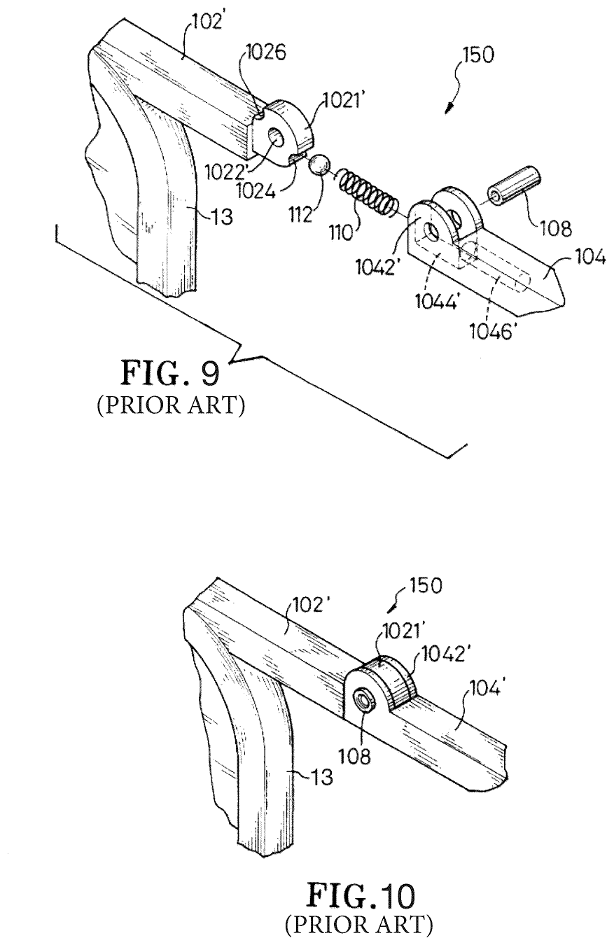

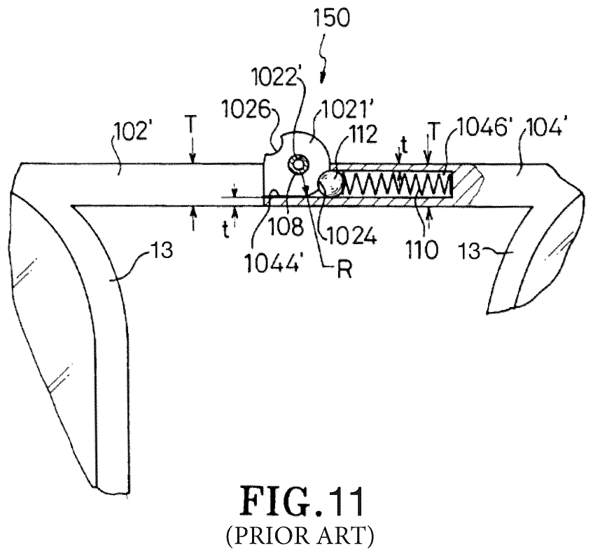

FIG. 9 is a partially enlarged and exploded perspective view illustrating a bridge device 150 of a further embodiment of U.S. Pat. No. 5,896,185. The differences between the bridge device 150 and the bridge device 100 illustrated in FIG. 6 reside in that, the bridge device 150 only includes a pivotal device, comprising a bridge block 102′ and a pivotal block 104′, which are integrally formed with the frames 13, 13′ and oppositely project from the upper inner ends of the frames 13, 13′, respectively. FIG. 11 illustrates the inter-relation among components, wherein the bridge block 102 has a thickness T and the free end thereof is formed with a substantially circular disk 1021′ having a radius R, on the center the disc 1021′ being formed with a pivotal opening 1022′. The central axis of the pivotal opening 1022′ is parallel to the normal axes of the frames 13 and preferred to extend along the same plan of the top surface of the bridge block 102′. The disk 1021′ radius R is smaller than the overall thickness T of the bridge block 102′ and the difference therebetween (T−R) is preferred to equal to the wall thickness t of the bridge block 102′. At the free end (located on the disk 1021′) of the bridge block 102′ and a spot (also located on the disk 1021′) being at an angle to the free end are respectively formed with recesses 1024′, 1026′.

The pivotal block 104′ preferably has an overall thickness equal to T and a wall thickness equal to t. A substantially semi-circular pivotal seat 1042′ projects from the top of the free end of the pivotal block 104′ and preferably has a radius equal to R. The pivotal block 104′ is pivotally connected to the bridge block 102′ by means of a pin 108 passing through the pivotal opening 1022′ and the pivotal seat 1042′. The pivotal seat 1042′ can be formed with a bottom stop block 1044′ for preventing the bridge device from rotating downwards. The pivotal block 104′ is formed with a horizontally blind hole 1046′ at the center thereof for receiving a compression spring 110 and a ball 112, wherein the ball 112 is disposed at the open end of the blind hole 1046′. The depth of the blind hole 1046′ is slightly larger than the length of the compression spring 110 such that the end of the ball 112 slightly protrudes out of the blind hole 1046′ after assembly, whereby the ball 112 is elastically secured within the recesses 1024′, 1026′ formed at the free end of the bridge block 102′. FIG. 10 illustrates the bridge device 100 after assembly.

In use, the recess 1024, 1024′ formed at the free end of the bridge block 102, 102′ is elastically secured to the ball 112 by means of the spring 110 as illustrated in FIGS. 8 and 11 such that the frames 12 are fixed to the expanded state of use.

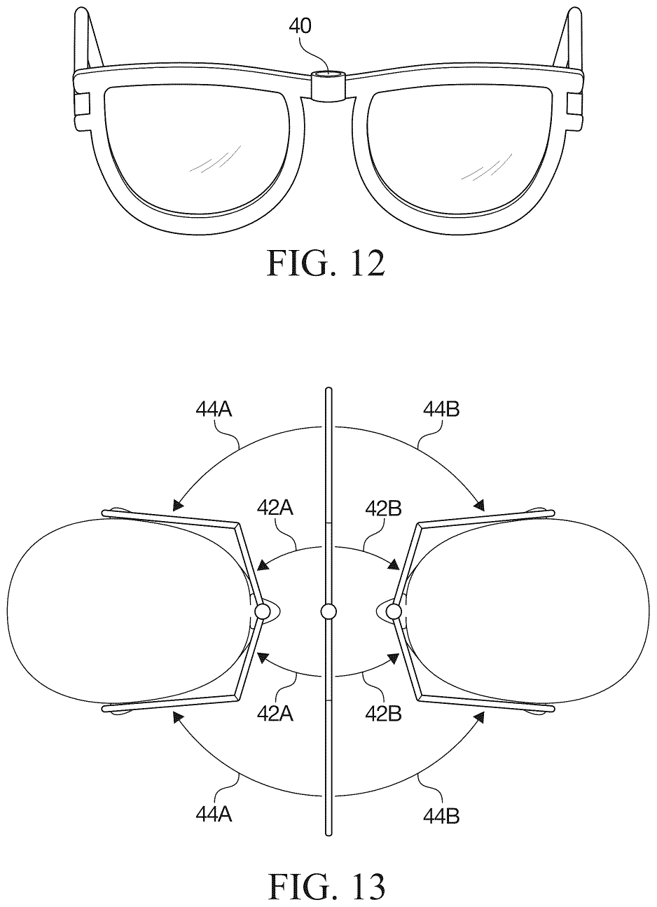

FIG. 12 show eye rim frames in accordance with the present invention that as a modification of those of U.S. Pat. No. 9,726,900 B1 in which a nose bridge unit 40 is between eye rim lens frames 16 that enables pivoting movement.

The nose bridge unit 40 may take the form of either of the bridge devices 100, 150 (FIGS. 6-8 and 9-11), except modified by rotating them 90 degrees instead and securing them in the 90 degrees rotation orientation. That way, instead of pivoting between an operative state and a stowed state of U.S. Pat. No. 5,896,185, the pivoting is between the two reverse orientations of U.S. Pat. No. 9,726,900 B1. The bridge devices 100, 150 could be replaced by a threaded screw rotatable in a threaded cylindrical surface that defines aligned holes (one over the other vertically) at the center with each hole part of a respective eye rim lens frame 16.

As an alternative, the nose bridge unit 40 may instead be made of malleable rubber or brushed nickel with soft malleable rubber to constitute a kind of rubber nose bridge. This allows the rubber nose bridge to bend under manual force to change the angle of inclination of the two eye rim lens frames 10 relative to the rubber nose bridge from being straight in alignment to angled in a manner that conforms to the contour of the wearer's face. An example of a conventional rubber nose bridge is set forth in U.S. Pat. No. 7,494,219 B2. The curled ends of the temple pieces 10 (FIGS. 1-5) wrap around the ears and, with the length of the temple pieces 10 sized accordingly, help maintain the lens frames 16 in their obtuse angulated orientation relative to each other.

As a further alternative, the nose bridge unit 40 may instead have threaded channel into which may be screwed a threaded stem of a screw. One of the lens frames is connected to the screw head and the other to the channel so that by turning the screw to rotate relative to the channel, the one lens frames rotate in unison with the screw and relative to the other lens frame. That allows the lens frames to define an obtuse angle between.

FIG. 13 illustrates the manner in which the reversible eyewear may fit onto a wearer's head by pivoting components accordingly. By pivoting the lens frames about the nose bridge unit 40 (FIG. 12), the lens frames may form an obtuse angle between after rotation either in the direction of rotation lines 42A or in the reverse in the direction of rotation lines 42B. If the direction of rotation is to be in accord with rotation lines 42A for the lens frames, then the eyewear temples should be pivoted in the direction of rotation lines 44A. If the direction of rotation is to be in accord with rotation lines 42B for the lens frames, then the eyewear temples should be pivoted in the direction of rotation lines 44B.

The present invention is therefore directed to a reversible orientation eyewear that has two eyewear temples, two eye rim lens frames; a nose bridge unit separating the two eye rim lens frames from each other, and two reversible pivot units pivotally connecting the two eyewear temples to the two eye rim frames respectively in a manner that enables the two eyewear temples to pivot laterally between two reversible orientations relative to the two eye rim frames such that in one of the reversible orientations, the two eyewear temples extend from the two eye rim frames in opposite directions from the manner than the two eyewear temples extend from the two eye rim frames in another of the two reversible orientations. The nose bridge unit connects the two eye rim frames in a manner that allows the two eye rim frames to pivot or move from an undeployed, 180 degrees angulation with respect to each other as shown in FIG. 13 to a deployed, obtuse angulated orientation with respect to each other for both of the reversible orientations as shown in FIG. 13.

While the foregoing description and drawings represent the preferred embodiments of the present invention, various changes and modifications may be made without departing from the scope of the present invention.

What is claimed is:

1. A reversible orientation eyewear, comprising:
two eyewear temple pieces;
two eye rim lens frames;
a nose bridge unit separating the two eye rim lens frames from each other;
two reversible pivot units pivotally connecting the two eyewear temples to the two eye rim lens frames respectively in a manner that enables the two eyewear temples to pivot between two reversible orientations relative to the two eye rim lens frames such that in one of the two reversible orientations, the two eyewear temples extend from the two eye rim frames in opposite directions from the manner than the two eyewear temples extend from the two eye rim frames in another of the two reversible orientations,
wherein the nose bridge unit connects the two eye rim lens frames in a manner that allows the two eye rim lens frames to move from an undeployed, 180 degree angulation position with respect to each other to a deployed, obtuse angulation position with respect to each other for each of the two reversible orientations.

2. The reversible orientation eyewear of claim 1, wherein the nose bridge unit includes pivot components that pivot the two eye rim frames relative to each other from the undeployed, 180 degree angulation position to each of the deployed, obtuse angulation positions for the two reversible orientations.

3. The reversible orientation eyewear of claim 1, wherein the nose bridge unit includes malleable rubber that is bendable to reorient the two eye rim frames relative to each other between the undeployed, 180 degrees angulation position and each of the two deployed, obtuse angulation positions for the two reversible orientations.

4. The reversible orientation eyewear of claim 1, wherein the nose bridge unit includes a rotatable screw engaged within a threaded channel that rotates at least one of the two eye rim frames relative to another of the two eye rim frames between the undeployed, 180 degrees angulation position and each of the two deployed, obtuse angulation positions for the two reversible orientations.

5. The reversible orientation eyewear of claim 1, wherein the nose bridge unit includes a hinge that pivots at least one of the two eye rim frames relative to another of the two eye rim frames between the undeployed, 180 degrees angulation position and each of the two deployed, obtuse angulation positions for the two reversible orientations.
